(19) United States
(12) Patent Application Publication
(10) Pub. No.: US 2004/0105540 A1
(43) Pub. Date: Jun. 3, 2004

(54) Housing for a telephone apparatus

(76) Inventor: Ashley Sayed, Birmingham (GB)

Correspondence Address: Gottlieb Rackman & Reisman, 270 Madison Avenue, New York, NY, 10016-0601, US

(21) Appl. No.: 10/468,503

(22) PCT Filed: Feb. 20, 2002
(86) PCT No.: PCT/GB02/00728

(30) Foreign Application Priority Data
Feb. 20, 2001 (GB) 0104151.6

(51) Int. Cl. H04M 1/00; H04M 9/00

(52) U.S. Cl. 379/428.01; 455/575.1

(57) ABSTRACT

A telephone apparatus comprises a transceiver module including electronic and electro-mechanical components for carrying out all essential functions of the apparatus. Front and rear housing members are releasably mountable to the apparatus by a user of the apparatus so as to enclose the module and thereby define the external appearance of the apparatus.

This invention relates to a telephone apparatus. More particularly, but not exclusively, the invention relates to a cellular telephone apparatus.

In accordance with the invention, there is provided a telephone apparatus comprising a transceiver module including electronic and electro-mechanical components for carrying out all essential functions of the apparatus, front and rear housing members being releasably mountable to the apparatus by a user of the apparatus so as to enclose the module and thereby define the external appearance of the apparatus.

This enables an end user of the apparatus to obtain a desired appearance of his or her telephone in a cheap and convenient fashion by mounting a desired front and rear housing member to the transceiver module, removing any previous front and/or rear housing member as necessary.

A keypad and/or lens may be held in position in the apparatus by engagement with the front housing member. This renders the keypad and/or lens replaceable.

Preferably, the transceiver module is adapted to accommodate at least two sizes of battery for supplying power to the apparatus, different respective rear housings being provided to accommodate the different sizes of battery. This is a convenient manner of providing, for example, optional NiMh and Lilon battery supplies with appropriately streamlined housings.

According to a further aspect of the invention, there is provided a front housing member and a rear housing member for a telephone, the members being releasably connectable directly to one another. The interconnectability of the housing members provides a convenient and attractive manner of supplying end users with an optional cosmetic appearance for a telephone apparatus they have already purchased.

A keypad and/or lens may be supplied together with the front and rear housing members.

According to a further aspect of the invention, there is provided a method of manufacturing a telephone comprising providing a fully functional transceiver module and releasably mounting front and rear housing members to the module.

According to a further aspect of the invention, there is provided a method of upgrading a telephone apparatus from lower tier to higher tier, comprising removing front and rear housing members of the apparatus and replacing them with housing members of different shape and/or colour.

In order that the invention may be well understood, an embodiment thereof will now be described, by way of example only, with reference to the accompanying drawing, which shows an exploded view of a telephone apparatus.

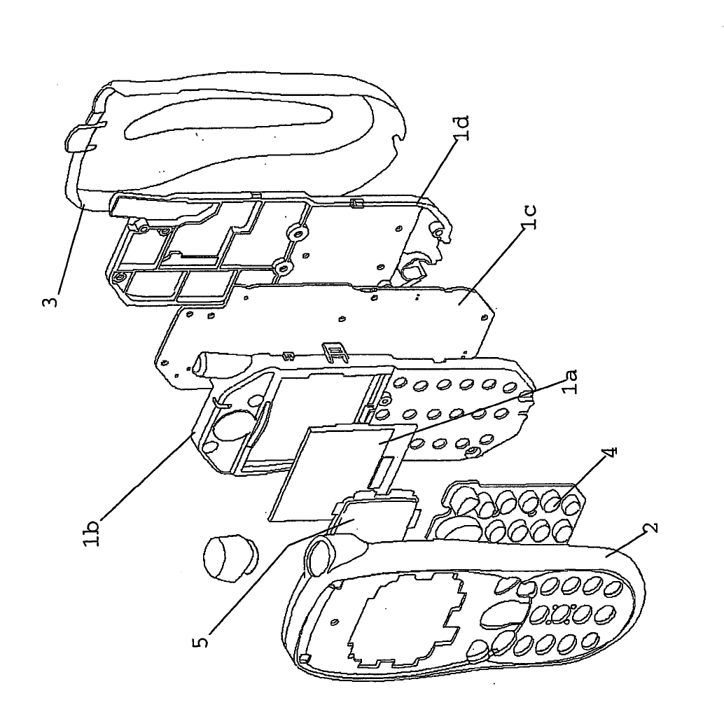

FIG. 1 shows a cellular telephone apparatus. The primary functions of the apparatus are provided by a transceiver module 1 which is fully operational in its own right. For example, the transceiver module incorporates a fully functional LCD display, means for transmitting and receiving voice and data signals, means for receiving an SIM card, an antenna, a microphone and an earpiece. The module is capable of receiving at least two types of battery, for example NiMh or Lilon batteries (not shown), which generally are of different size and shape. The four parts 1a, 1b, 1c, 1d of the transceiver module shown in FIG. 1 are mounted together during manufacture to provide a unitary module 1, and are not intended to be separated from one another by an end user of the apparatus.

The apparatus further comprises respective front and rear housing members 2 and 3, which function as cosmetically attractive outer covers. The front member 2 is releasably mountable to the transceiver module 1 by snap-engagement of the plastics member with mounting means on the module 1. The rear member 3 is releasably mountable to the apparatus by snap-engagement with the front member 2. Of course, alternatively, the rear member could be mounted to the module 1 and the front member mounted to the rear member. A keypad 4 and a lens 5 are adapted to engage the front cover so as to be mountable to the apparatus by engagement of the front cover 2 with the module 1. Clearly, whilst snap-engagement is a particularly convenient and effective method of mounting the members 2 and 3 to the apparatus, other releasable mounting means could be employed.

The modular construction described above enables a single type of transceiver module to be employed in telephones having completely different appearance. Replacement housing members 2, 3 can be presented for sale in a particularly attractive manner by clipping the front and rear members 2, 3 together, with or without a replacement keypad and/or lens, and can be used as part of a method of upgrading a cellular telephone from a lower tier phone to a higher tier phone. As part of such a method, software functions of the module 1 and/or the type of battery used can be upgraded, and the colour and configuration of the housing members 2, 3 selected according to the performance of the upgraded apparatus. In particular, the configuration of the rear housing member 3 can be selected so as to accommodate the desired battery type and to streamline the housing to the size of the module with battery. The keypad and lens can be selected to match the colour and/or shape of the housings and/or the new functions of the phone.

The module 1 is fully enclosed by the housing members 2, 3, providing the RF shielding for the PCB 1c of the module.

A vibrator option can be provided.

Using the modular system described above, the apparatus can be configured by the manufacturer to meet specific customer requirements at a late stage in manufacture. Customer specific software, logos, colours and battery requirements can be flexibly accommodated. Furthermore, the apparatus can be conveniently customized by an end user of the apparatus.

1. A telephone apparatus comprising a transceiver module including electronic and electro-mechanical components for carrying out all essential functions of the apparatus, front and rear housing members being releasably mountable to the apparatus by a user of the apparatus so as to enclose the module and thereby define the external appearance of the apparatus.

2. The telephone apparatus of claim 1 wherein a keypad and/or lens is held in position in the apparatus by engagement with the front housing member.

3. The telephone apparatus of claim 1 or claim 2 wherein the transceiver module is adapted to accommodate at least two sizes of battery for supplying power to the apparatus, different respective rear housings being provided to accommodate the difference sizes of battery.

4. The telephone apparatus of any preceding claim further comprising one or more alternative front and/or rear housing members for providing alternative shape and/or colour and/or surface texture to said apparatus.

5. The telephone apparatus of any preceding claim wherein said front and/or rear housing members define an appearance representative of a telephone supplier and/or telecommunications service provider.

6. A front housing member and a rear housing member for a telephone, the members being releasably connectable directly to one another.

7. A keypad and/or lens for mounting by engagement with the front and rear housing members of claim 6.

8. A method of manufacturing a telephone comprising providing a fully functional transceiver module and releasably mounting front and rear housing members to the module.

9. A method of upgrading a telephone apparatus from lower tier to higher tier, comprising removing front and rear housing members of the apparatus and replacing them with housing members of different shape and/or colour and/or texture.

10. A telephone apparatus substantially as herein described with reference to the drawing of FIG. 1.
